(19) United States
(12) Patent Application Publication
(10) Pub. No.: US 2012/0219793 A1
(43) Pub. Date: Aug. 30, 2012

(54) POLYHEDRAL OLIGOMERIC SILSESQUIOXANE COMPOSITIONS, METHODS OF USING THESE COMPOSITIONS, AND STRUCTURES INCLUDING THESE COMPOSITIONS

(76) Inventors: Nathan Fritz, Atlanta,, GA (US); Paul Kohl, Atlanta, GA (US); Rajarshi Saha, Atlanta, GA (US)

(21) Appl. No.: 13/508,294

(22) PCT Filed: Nov. 9, 2010
(86) PCT No.: PCT/US10/55994

§ 371 Date: May 4, 2012

Related U.S. Application Data
(60) Provisional application No. 61/259,858, filed on Nov. 10, 2009.

(51) Int. Cl. B32B 27/00; C08L 83/06; B05D 3/00; C08G 77/14

(52) U.S. Cl. 428/339; 528/37; 524/868; 427/331

(57) ABSTRACT

Embodiments of the present disclosure include functionalized polyhedral oligomeric silsesquioxane compositions or mixtures, methods of using functionalized polyhedral oligomeric silsesquioxane compositions, structures including functionalized polyhedral oligomeric silsesquioxane, and the like.

### CROSS-REFERENCE TO RELATED APPLICATION

This application claims priority to U.S. provisional application entitled, “PHOTOSENSITIVE GLASS/POLYMER OVERCOAT FOR AIR CAVITIES,” having Ser. No. 61/259,858, filed on Nov. 10, 2009, which is entirely incorporated herein by reference.

### BACKGROUND

Polymers are widely used as dielectric materials in microelectronic and microfluidic devices. Epoxy-based polymer materials can be patterned and have appropriate mechanical characteristics for use as overcoats in microelectromechanical systems (MEMS) packaging and microfluidic channels created through the use of sacrificial polymers. However, epoxy-based polymer overcoats can deform during thermal processing, lack adequate mechanical strength, and have similar reactive ion etching (RIE) characteristics as sacrificial polymers when used in MEMS packaging. Inorganic materials, such as plasma deposited silicon dioxide, have been used in pattern-transfer to organic films because of their high RIE selectivity (etch rate of the polymer relative to the etch rate of the pattern-transfer material). However, a non-photosensitive pattern-transfer material may require a third, photosensitive later (i.e., tri-layer process). Plasma deposited inorganic masks can be brittle and require relative high deposition temperature. In addition, plasma deposited glass requires costly deposition facilities and the films can be highly stressed. Therefore, alternatives to these are desirable.

### SUMMARY

Embodiments of the present disclosure include functionalized polyhedral oligomeric silsesquioxane compositions or mixtures, methods of using functionalized polyhedral oligomeric silsesquioxane compositions, structures including functionalized polyhedral oligomeric silsesquioxane, and the like.

In particular, an embodiment includes a composition, among others, that includes: a functionalized polyhedral oligomeric silsesquioxane and a photocatalyst, wherein the functionalized polyhedral oligomeric silsesquioxane includes a cross-linkable group, wherein the functionalized polyhedral oligomeric silsesquioxane is about 80 to 99.9 weight % of the composition, and the photocatalyst is about 0.01 to 5 weight % of the composition, and optionally about 0.01 to 10 weight % of one or more additional components.

In particular, an embodiment includes a composition, among others, that consists essentially of: a functionalized polyhedral oligomeric silesquixane and a photocatalyst, and optionally an additional component, wherein the functionalized polyhedral oligomeric silsesquioxane includes a cross-linkable group.

In particular, an embodiment includes a composition, among others, that consists of: a functionalized polyhedral oligomeric silsesquioxane and a photocatalyst, wherein the functionalized polyhedral oligomeric silsesquioxane includes a cross-linkable group, where the functionalized polyhedral oligomeric silsesquioxane and the photocatalyst are dissolved in a solvent, and optionally an additional component.

In particular, an embodiment includes a structure, among others, that includes: a second layer made of a composition comprising a functionalized polyhedral oligomeric silsesquioxane that is disposed on a portion of a first layer, wherein the first layer is disposed on a substrate, wherein the second layer has a thickness of about 1 to 50 μmeters.

In particular, an embodiment includes a method, among others, that includes: disposing a second layer made of a composition comprising a functionalized polyhedral oligomeric silsesquioxane on a portion of a first layer, wherein the first layer is disposed on a substrate, wherein the second layer has a thickness of about 1 to 50 μmeters; removing a portion of the second layer to expose a portion of the first layer; and removing the portion of the first layer that is not covered by the second layer. In an embodiment, the method also includes: disposing a third layer on the second layer and the first layer, wherein the second layer and the third layer (and/or the substrate) enclose a three dimensional area of the first layer; and removing the three dimensional area of the first layer to form a three dimensional gas cavity, where the second layer and the third layer enclose the three dimensional gas cavity.

Other systems, methods, features, and advantages of the present disclosure will be, or become, apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1.1A illustrates an embodiment of a structure of the present disclosure.

FIG. 1.1B illustrates an embodiment of a structure of the present disclosure.

FIG. 1.1C illustrates an embodiment of a structure of the present disclosure.

FIGS. 1.2A to 1.2D illustrate an embodiment of a process for forming the structure shown in FIG. 1.1A.

FIGS. 1.3A to 1.3G illustrate an embodiment of a process for forming the structure shown in FIG. 1.1A.

FIG. 2.1 illustrates the chemical structure of epoxycyclohexyl polyhedral oligomeric silsesquioxane (POSS) cage (C₈H₁₃O₂)ₙ(SiO_{1.5})ₙ, when n=8.

FIG. 2.2 illustrates a schematic of the fabrication process for a MEMS package cavity. (a) Fabricated MEMS device (black). (b) Spin coat PPC (light gray) and POSS (medium gray) layers. (c) Pattern POSS mask. (d, e) Pattern PPC using the POSS mask in RIE. (f) Apply Overcoat material. (g) Decompose PPC and cure polymers. (h) Evaporate Al layer (dark gray).

FIG. 2.3 illustrates the spin speed curves for POSS films from 40 and 60 wt % of POSS in solution.

FIG. 2.4 illustrates a contrast curve for photodefined epoxycyclohexyl POSS of 1 μm thickness.

FIG. 2.5 illustrates changes in the absorption coefficient for the POSS film over the wavelengths 225-500 nm.

FIG. 2.6 illustrates S.E.M. images of 10 μm thick photodefined POSS. (a) Arrays of photodefined POSS lines ranging from 5 to 50 μm width with equal lines and spaces. (b) Array of 50 μm wide POSS lines.

FIG. 2.7 illustrates a thermal gravimetric analysis of POSS film to 500° C. at a ramp rate of 1° C./min.

FIG. 2.8 illustrates (a) S.E.M. image of a 3 μm thick line of polypropylene carbonate with a 1 μm patterned POSS mask after an O₂ plasma RIE. (b) A schematic of the Patterned PPC/POSS line.

FIG. 2.9 illustrates (a) S.E.M. image of a cavity utilizing a POSS mask with an Avatrel 2000P overcoat. The width of the cavity is 50 μm and has a height of 3 μm. (b) A close up of the corner of the cavity in (a). The POSS mask, Avatrel 2000P overcoat and aluminum cap have been identified and measured.

FIG. 2.10 illustrates an all POSS overcoat cavity designed for a resonator. A 1 μm Al layer is on top of the 2 μm POSS overcoat. The trenches in the wafer show where the resonator would be located.

FIG. 2.11 illustrates Table 1, which illustrates the POSS etch rates and selectivity in 250 W O₂ plasma with different CHF₃ concentrations. The Selectivity is for a polypropylene carbonate etch rate of 0.66 μm/min.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, electronics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

The term “substituted” refers to any one or more hydrogens on the designated atom that can be replaced with a selection from the indicated group, provided that the designated atom's normal valence is not exceeded, and that the substitution results in a stable compound. When a substituent is keto (i.e., C—C(═O)—C), then 2 hydrogens on the atom can be replaced. When a ring system (e.g., carbocyclic or heterocyclic) is said to be substituted with a double bond, it is intended that the carbonyl group or double bond be part of the ring.

The term “aliphatic” refers to a saturated or unsaturated linear or branched hydrocarbon group and cyclic hydrocarbons, and encompasses alkyl, alkenyl, and alkynyl groups, for example.

As used herein, “alkyl” or “alkyl group” refers to a saturated aliphatic hydrocarbon radical that can be straight or branched, having 1 to 20 carbon atoms, where the stated range of carbon atoms includes each intervening integer individually, as well as sub-ranges. Examples of alkyl include, but are not limited to, methyl, ethyl, n-propyl, i-propyl, n-butyl, s-butyl, t-butyl, n-pentyl, and s-pentyl. The term “lower alkyl” means an alkyl group having less than 10 carbon atoms.

As used herein, “alkenyl” or “alkenyl group” refers to an aliphatic hydrocarbon radical that can be straight or branched, containing at least one carbon-carbon double bond, having 2 to 20 carbon atoms, where the stated range of carbon atoms includes each intervening integer individually, as well as sub-ranges. Examples of alkenyl groups include, but are not limited to, ethenyl, propenyl, n-butenyl, i-butenyl, 3-methylbut-2-enyl, n-pentenyl, heptenyl, octenyl, decenyl, and the like.

The term “arylalkyl” refers to an arylalkyl group wherein the aryl and alkyl are as herein described. Examples of arylalkyl include, but are not limited to, -phenylmethyl, phenylethyl, -phenylpropyl, -phenylbutyl, and -phenylpentyl.

The term “substituted,” as in “substituted alkyl”, “substituted cycloalkyl,” “substituted cycloalkenyl,” substituted aryl,” substituted biaryl,” “substituted fused aryl” and the like means that the substituted group may contain in place of one or more hydrogens a group such as hydroxy, amino, halo, trifluoromethyl, cyano, —NH(lower alkyl), —N(lower alkyl)₂, lower alkoxy, lower alkylthio, or carboxy, and thus can embrace the terms haloalkyl, alkoxy, fluorobenzyl, and the sulfur and phosphorous containing substitutions.

As used herein, “halo”, “halogen”, or “halogen radical” refer to a fluorine, chlorine, bromine, iodine, and radicals thereof. Further, when used in compound words, such as “haloalkyl” or “haloalkenyl”, “halo” refers to an alkyl or alkenyl radical in which one or more hydrogens are substituted by halogen radicals. Examples of haloalkyl include, but are not limited to, trifluoromethyl, trichloromethyl, pentafluoroethyl, and pentachloroethyl.

The term “aryl” as used herein, refers to an aromatic monocyclic or multicyclic ring system of about 6 to about 14 carbon atoms, preferably of about 6 to about 10 carbon atoms.

The term “heteroaryl” is used herein to denote an aromatic ring or fused ring structure of carbon atoms with one or more non-carbon atoms, such as oxygen, nitrogen, and sulfur, in the ring or in one or more of the rings in fused ring structures. Examples are furanyl, pyranyl, thienyl, imidazyl, pyrrolyl, pyridyl, pyrazolyl, pyrazinyl, pyrimidinyl, indolyl, quinolyl, isoquinolyl, quinoxalyl, and quinazolinyl. Preferred examples are furanyl, imidazyl, pyranyl, pyrrolyl, and pyridyl.

The term “alkoxy” represents an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. The term “lower alkoxy” means an alkoxy group having less than 10 carbon atoms.

The term “epoxy group” is used to denote a pair of carbon atom each bonded to the same oxygen atom, and each carbon atom is bonded to one or two R groups. The terms ketone, ester, ether, and acyl have their art recognized meanings.

### Discussion

Embodiments of the present disclosure include functionalized polyhedral oligomeric silsesquioxane compositions or mixtures, methods of using functionalized polyhedral oligomeric silsesquioxane compositions, structures including functionalized polyhedral oligomeric silsesquioxane, and the like. Embodiments of the present disclosure can be used in electronics (e.g., microelectromechanical systems (MEMS) and nanoelectromechanical systems (NEMS)), microfluidics, separation technologies, optical technologies, and the like.

In general, there are three classifications of materials that can be used as a barrier film or layer in microelectronics and these include organic materials, inorganic materials, and hybrids. Organic materials (polymers) can provide low impact deposition (usually spin coating). These materials can be functionalized to obtain some properties (i.e., hydrophobicity). Many organic films can be easily patterned through photodefinition, for example. However, many organic films have low mechanical properties with modulus of less than 3 GPa. The films usually have trade-offs with low chemical resistance and thermal degradation depending on chemical structure. When used as a dry etch mask, the organic films will only have high selectivity with inorganic compounds. For these reasons, organic films are limited in most top film applications.

Inorganic materials can be broken into two categories of electrically insulating or conductive. These materials have high elastic modulus usually greater than 50 GPa and excellent thermal stability properties. These materials have high etch selectivity in plasma with respect to most organic materials. Inorganics can easily be etched by the appropriately chosen acid systems or by plasma conditions different from organic materials. Organic materials are plasma etched using mostly oxygen to produce carbon dioxide and water. The disadvantages for inorganic barriers can be cost. Inorganic films are not easily modified for functionality which limits them to the intended properties of that particular film or their required removal after the process is complete. Most inorganic films require costly deposition plasma systems, such as used to produce plasma assisted silicon dioxide or silicon nitride. These systems require specialized high temperature and specialized environments that could damage the underlying film. Deposited films are high stress and brittle resulting in cracks and poor adhesion. Inorganic materials cannot naturally be patterned. To pattern an inorganic material, a photodefineable organic material must be used to transfer the pattern, which limits pattern transfer to the bottom film to a tri-layer pattern system.

Some hybrid materials try to take advantage of particular advantages of both of the organic and inorganic classes. Depending on the combination and amount of organic components and glass components, the material can show functions of each. Care must be taken when dealing with hybrids to obtain the required properties. A few examples include sol-gel, spin on glasses, and functionalized polyhedral oligomeric silsesquioxane (POSS) materials.

Sol gel materials tend to be small monomers that can crosslink to networks with low to moderate SiOₓ levels and moderate sized regions. The polymers are low impact deposition and highly functionable. The modulus can be very low to high. However, high modulus often results in films which are brittle or stressed with poor crack resistance. Dry etch selectivity is moderate but inconsistent with organic materials. The monomer can be a liquid at room temperature or a solid dissolved in a liquid. The low crack resistance limits the film thicknesses values less than 1 μm. For this reason most sol-gel materials are poor candidates for more than just coating materials.

Spin-on-glasses include hydrogen silsesquioxane (HSQ) and methyl silsesquioxane. These materials include ladder-style sheets of SiOₓ with methyl or hydrogen surrounding the edges. As a low-k material with good adhesion and thermal properties, they have played a role in the microelectronics industry. However, these materials require advanced patterning techniques and result in ultra thin films (less than 1 μm). These thin films provide little mechanical support and are too thin to be used as a patterning mask.

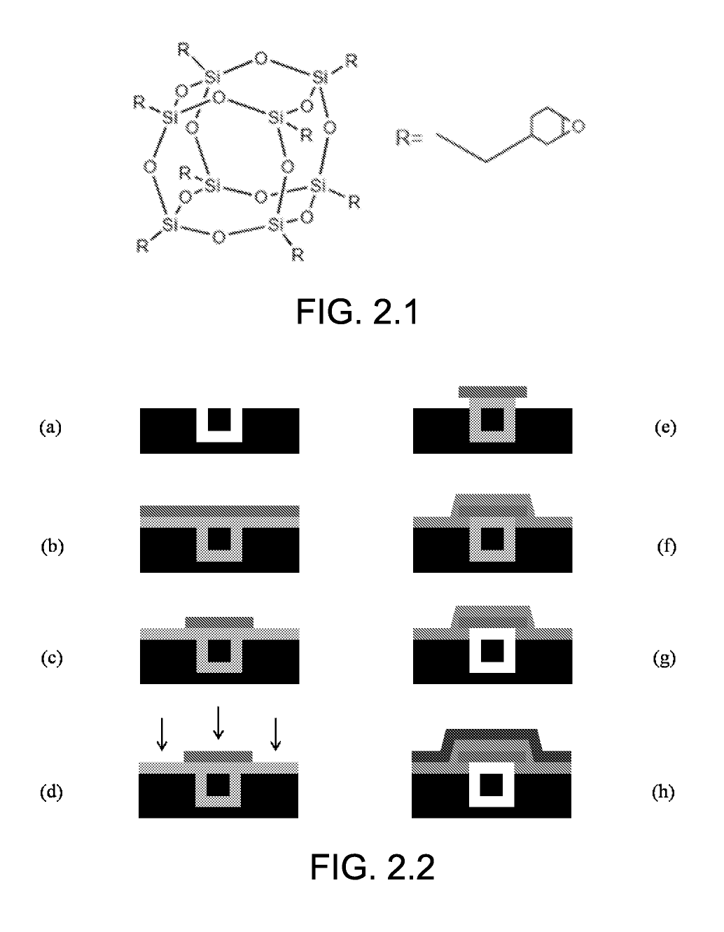

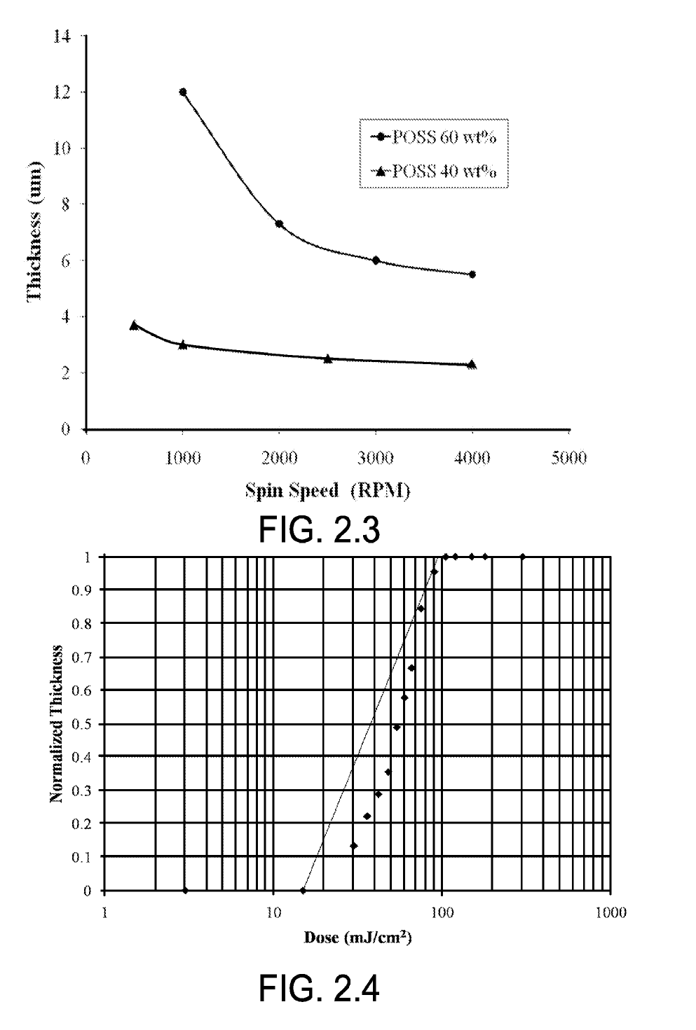

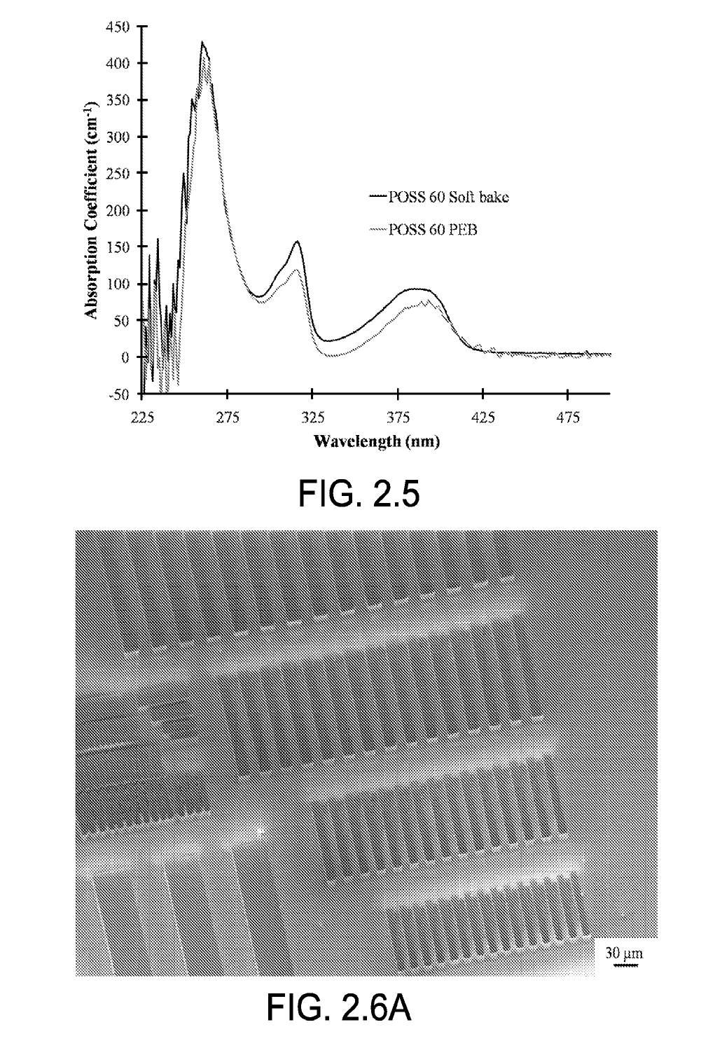

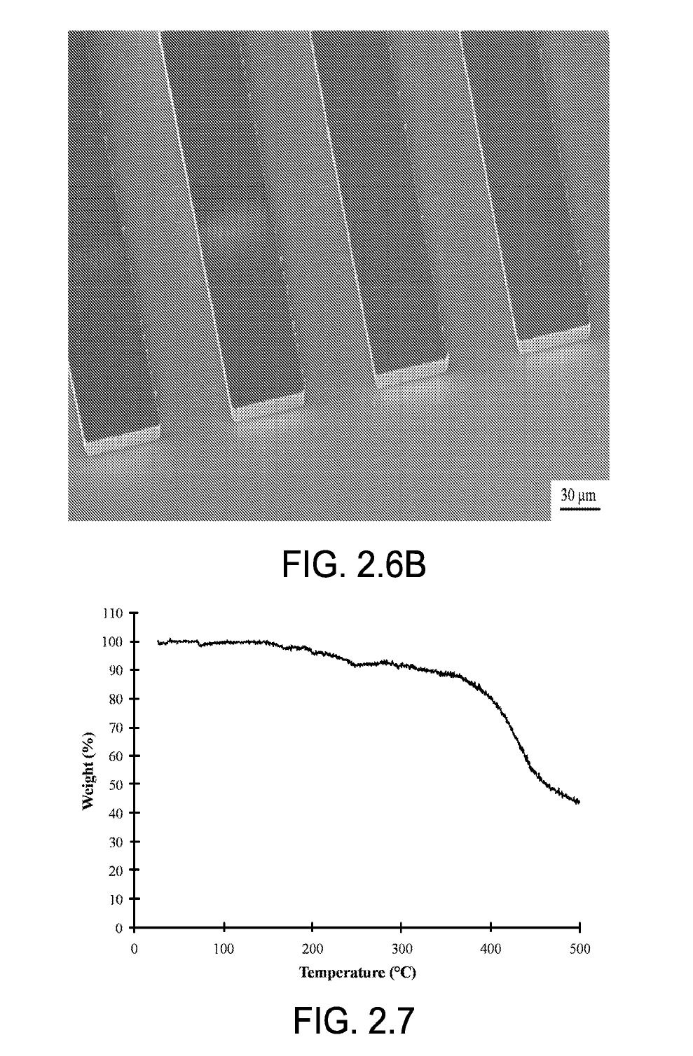

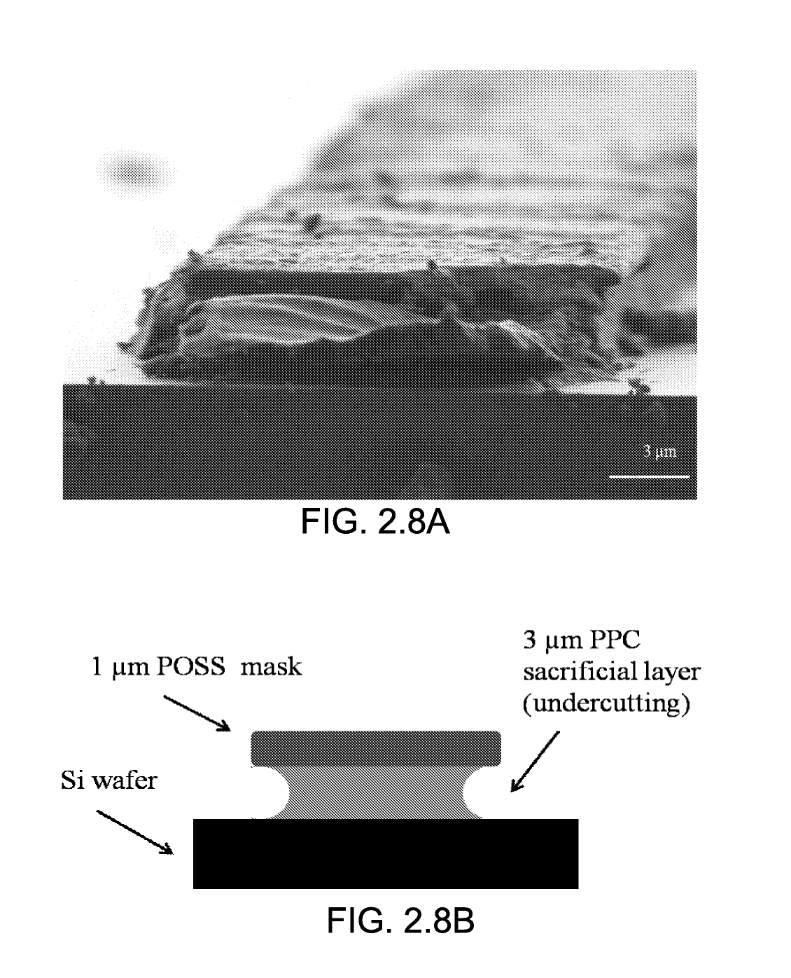

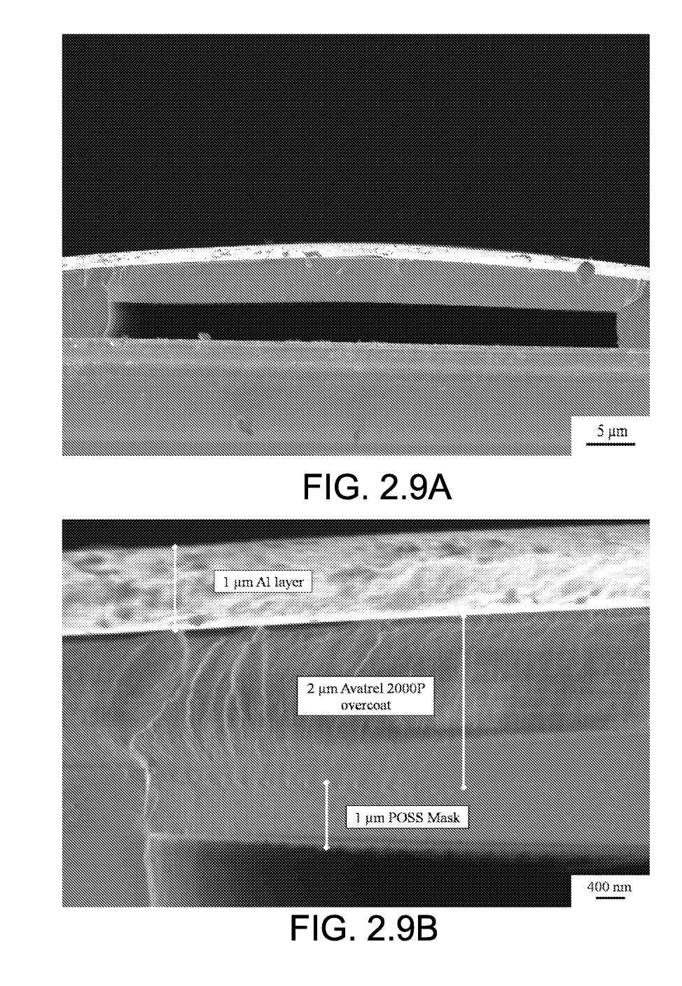

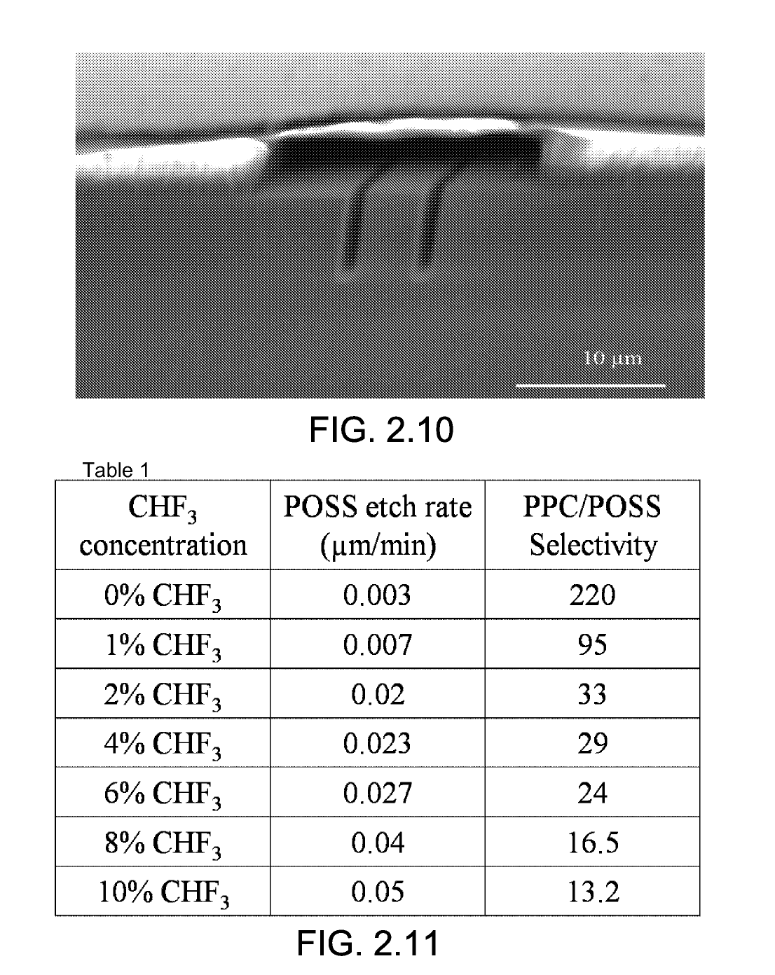

Functionalized polyhedral oligomeric silsesquioxane materials can provide unique advantages due to having a three dimensional cage structure. The structure contains the smallest unit of quartz that can be functionalized with organic arms (R groups). The three dimensional cage can have 8, 10 or 12 corners, and Si molecules are positioned at each corner and an R group can be attached to the Si. The SiOₓ cage structure (See FIG. 2.1) provides a strong mechanical backbone for mechanical support and enough SiOₓ for etch resistance. The organic function (R group) on the corner of the cages allows for high functionality and can form polymers via cross linking.

For example, in an embodiment the R groups can be an epoxy group since they can crosslink with other groups. In this regard, the epoxies on the corner allow for a high amount of cross-linking in to a dense network. The epoxies can provide high strength to the material, chemical resistance, and adhesion compared to other possible groups. In an embodiment, the epoxy functioned polyhedral oligomeric silsesquioxane can be matched with a photocatalyst, such as a photo-acid generator, and/or a solvent, for use as a spin casted, photodefineable film that can be used in microelectronics, for example.

As described above, functionalized polyhedral oligomeric silsesquioxane materials are advantageous since they combine some of the advantages of other materials without some of the disadvantages. However, functionalized polyhedral oligomeric silsesquioxane materials are known to have higher CTE than other spin-on glasses. Functionalized polyhedral oligomeric silsesquioxane materials have a random orientation of the cage structure with a high crosslink density due to the possibility of 8-12 maximum cross-linking sites. Based on this, researchers may hypothesis that these cross-linking sites would have little mobility so that after reaction there is considerable bond-strain resulting in brittleness and high internal stress. The combination of these properties would lead most researchers to hypothesize that the cross-linked functionalized polyhedral oligomeric silsesquioxane film would have excessive stress and only be useful in extremely thin-films where the stress does not exceed a critical value and cause cracking. This has lead many researchers to use mixtures of functionalized polyhedral oligomeric silsesquioxane and organic materials. Others use functionalized polyhedral oligomeric silsesquioxane as an additive only to control cross-linking and add bond flexibility to achieve a trade off in mechanical and etch resistant properties as opposed to being used as the primary or only monomer at high concentrations.

Unexpectedly, functionalized polyhedral oligomeric silsesquioxane materials of the present disclosure can be spin coated to about 1 to 50 μm without the expected stress effects, where the thickness can be controlled by selection of the solvent. Although not intending to be bound by theory, the cage structures of the functionalized polyhedral oligomeric silsesquioxane and some cross-linking could have contributed to the free volume within the solid film. While some free volume is desirable for the gas permeable application, an excess of this free volume or excessive large free volume (e.g., porosity) would expose inner portions of the matrix and the underlying material to be chemically etched and subsequently ruin the films. The uniform rigid bond lengths and the high cross-linked matrix help control the amount of porosity that allows embodiments of the present disclosure to provide unexpected results.

Another expected problem when using functionalized polyhedral oligomeric silsesquioxane is the removal of a functionalized polyhedral oligomeric silsesquioxane mask in a microelectronic process after RIE etching of a sacrificial layer (e.g., polypropylene carbonate (PPC)). However, the functionalized polyhedral oligomeric silsesquioxane mask can be precisely spin-coated such that it is completely etched off during organic patterning. Any left-over residue from functionalized polyhedral oligomeric silsesquioxane mask can be removed with a further plasma etch.

Thus, functionalized polyhedral oligomeric silsesquioxane materials of the present disclosure and uses thereof are advantageous over other alternatives and provide unexpected and desirable results.

Functionalized polyhedral oligomeric silsesquioxane is a cage-shaped oligomer that can be represented by the formula Rₙ(SiO_{1.5})ₙ, where n is 8, 10, or 12, which are also the number of corners of the cage. In an embodiment, n can be up to 20 or 30. Functionalized polyhedral oligomeric silsesquioxane chemical structures can have n number of corners, Si is located at each corner, and a R group is attached to the Si. The functionalized polyhedral oligomeric silsesquioxane structure is a three dimensional cage structure presenting a three dimensional matrix (See Example 1, FIG. 2.1 for an embodiment of a functionalized polyhedral oligomeric silsesquioxane having a single type of R group and eight Si) unlike the layered ladder design of other silsesquioxanes (MSQ). The functionalized polyhedral oligomeric silsesquioxane includes a cross-linkable group (one or more of the R groups) so that the molecules can be bonded together. Each R group can independently be selected from: a substituted or unsubstituted cyclic aliphatic group, a substituted or unsubstituted linear aliphatic group, a substituted or unsubstituted aryl group, and a combination thereof. The substitution can include one or more cross-linkable groups selected from: an alcohol, an ester, an amine, an imide, a ketone, an olefin, an ether, a norbornenyl, a carboxylic acid, or a halide. In an embodiment, the cross-linkable R groups are independently selected from: an epoxy group (e.g., epoxycyclohexyl, glycidyl), alkoxy (e.g. methoxy, ethoxy), alkyl (e.g. methyl, ethyl, proply), methacrylates, acrylates, and the like.

In an embodiment, the functionalized polyhedral oligomeric silsesquioxane composition can include functionalized polyhedral oligomeric silsesquioxane and a photocatalyst. In an embodiment, the functionalized polyhedral oligomeric silsesquioxane is about 80 to 99.9, about 85 to 99.9, about 90 to 99.9, about 95 to 99.9, or about 98 to 99.9, weight % of the composition and the photocatalyst is about 0.01 to 5 or about 0.1 to 2, weight % of the composition. In another embodiment, the functionalized polyhedral oligomeric silsesquioxane composition can also include one or more additional components (e.g., sensitizer), where the total amount of the additional components is about 0.01 to 20, about 0.01 to 10, about 0.01 to 5, or about 0.01 to 1, weight % of the composition. In an embodiment, the functionalized polyhedral oligomeric silsesquioxane composition can be dissolved in a solvent and used, for example, in the fabrication of electronic and microfluidic structures.

In an embodiment, the photocatalyst can include photoacid generator catalysts. In an embodiment, the photoacid generator catalyst can be selected from: triflic acid group catalysts (e.g., (tert-Butoxycarbonylmethoxynaphthyl)-diphenylsulfonium triflate, Bis(4-tert-butylphenyl)iodonium triflate, N-Hydroxynaphthalimide triflate); nonaflic acid group catalysts (e.g., Diphenyliodonium perfluoro-1-butanesulfonate, Tris(4-tert-butylphenyl)sulfonium perfluoro-1-butanesulfonate, N-Hydroxynaphthalimide perfluoro-1-butanesulfonate); FABA acid group catalysts (e.g., 4-Methylphenyl[4-(1-methylethyl)phenyl]iodonium tetrakis (pentafluorophenyl)borate, Tris(4-tert-butylphenyl)sulfonium tetrakis-(pentafluorophenyl)borate, Triphenylsulfonium tetrakis-(pentafluorophenyl)borate), sulfonate (non-fluorinated) acid group catalysts (e.g., Bis(4-tert-butylphenyl)iodonium p-toluenesulfonate, Diphenyliodomium 9,10-dimethoxyanthracene-2-sulfonate, Ciba non-ionic photoacid generator), and other photocatlysts such as: Bis(4-tert-butylphenyl)iodonium tris(perfluoromethanesulfonyl)methide, Bis(4-tert-butylphenyl)iodonium bis(perfluorobutanesulfonyl)imide, and Bis(4-tert-butylphenyl)iodonium perfluoro-1-octanesulfonate, and combinations thereof.

In an embodiment, the solvent can be selected from mesitylene, glycidyl, vinyl, gamma butyrolactone, ketone, alcohols, N-methylpyrollidone, propylene glycol methyl ether acetate, anisole, and a combination thereof. In an embodiment, the solvent can be mesitylene. In an embodiment, about 1 to 70 wt % of the functionalized polyhedral oligomeric silsesquioxane composition can be dissolved in the solvent. In another embodiment, about 1 to 40 wt % of the functionalized polyhedral oligomeric silsesquioxane composition can be dissolved in the solvent.

In an embodiment, the additional components can be selected from: a sensitizer (e.g., a compound designed to absorb radiation in a region of the electromagnetic spectrum where functionalized polyhedral oligomeric silsesquioxane and the solvents don't absorb) (about 0.01 to 5 wt %), an anti-oxidant (about 0.01 to 5 wt %), an adhesion promoter (e.g., 3-amino proply silane) (about 0.01 to 2 wt %), and a combination thereof.

In an embodiment, the functionalized polyhedral oligomeric silsesquioxane composition consists essentially of a functionalized polyhedral oligomeric silsesquioxane and a photocatalyst. In an embodiment, the functionalized polyhedral oligomeric silsesquioxane composition consists essentially of functionalized polyhedral oligomeric silsesquioxane, a photocatalyst, and one or more additional components. In an embodiment, the functionalized polyhedral oligomeric silsesquioxane composition consists essentially of a functionalized polyhedral oligomeric silsesquioxane and a photocatalyst, where both are dissolved in a solvent, and optionally including one or more additional components that are also dissolved in the solvent. The phrases “consisting essentially of or “consists essentially” or the like, when applied to compositions or mixtures or their uses encompassed by the present disclosure refer to compositions like those disclosed herein, but which may contain additional composition components. Such additional composition components, however, do not materially affect the basic and novel characteristic(s) of the compositions, compared to those of the corresponding compositions or methods disclosed herein. “Consisting essentially of or “consists essentially” or the like, when applied to compositions encompassed by the present disclosure have the meaning ascribed in U.S. patent law and the term is open-ended, allowing for the presence of more than that which is recited (e.g., trace contaminants, non-active components (e.g., metals, alkali metals, hydrocarbons, etc), and the like) so long as basic or novel characteristics of that which is recited is not changed by the presence of more than that which is recited, but excludes prior art embodiments.

In an embodiment, the functionalized polyhedral oligomeric silsesquioxane composition consists of a functionalized polyhedral oligomeric silsesquioxane and a photocatalyst. In an embodiment, the functionalized polyhedral oligomeric silsesquioxane composition consists of a functionalized polyhedral oligomeric silsesquioxane, a photocatalyst, and one or more additional components. In an embodiment, the functionalized polyhedral oligomeric silsesquioxane composition is dissolved in a solvent.

Embodiments of the functionalized polyhedral oligomeric silsesquioxane composition can be used in electronic devices such as microelectronics, MEMS, NEMS, and optical components or microfluidics devices. In an embodiment, the functionalized polyhedral oligomeric silsesquioxane composition can be dissolved in a solvent and can form layers including the functionalized polyhedral oligomeric silsesquioxane composition, where the characteristics of the functionalized polyhedral oligomeric silsesquioxane composition can be advantageously used. In particular, embodiments of the functionalized polyhedral oligomeric silsesquioxane composition can be used as a material to produce photo-patternable mechanically strong permanent microfabrication polymeric material, as a Reactive Ion Etch (Plasma etch) mask (e.g., for organic materials), as a hydrophobic coating, as a chemical/oxygen plasma resistant barrier, as a high modulus polymeric barrier/structural material (e.g., used in hermetic seals for MEMS devices), as a gas permeable membrane, barrier, and/or overcoat, in the decomposition and release of encapsulated sacrificial materials in the formation of air-gap structures, and the like.

For example, to accomplish one or more of the uses described above, embodiments of the functionalized polyhedral oligomeric silsesquioxane composition dissolved in a solvent can be disposed on a substrate (e.g., used in electronics or microfluidics) via spin coating, dip coating, meniscus coating, or spray coating. The thickness of the coating disposed on the substrate can be controlled, at least in part, by the selection of the solvent and the functionalized polyhedral oligomeric silsesquioxane composition.

Once the functionalized polyhedral oligomeric silsesquioxane composition is disposed on a substrate, the layer is photodefineable on the micrometer and larger scales and has a contrast of about 0.2 to 10, about 1 to 2, or about 1.51.

Embodiments of the layer can be about 1 to 50 μm, about 2 to 25 μm, about 2 to 20 μm, or about 2 to 15 μm (e.g., about 1 μm, about 2 μm, about 3 μm, about 4 μm, about 5 μm, about 6 μm, about 7 μm, about 8 μm, about 9 μm, about 10 μm, and so on, to about 10 μm, about 15 μm, about 20 μm, about 25 μm, about 30 μm, about 40 μm, about 45 μm, about 50 μm, and so on, in any combination (e.g., about 2 to 10 μm or about 2 to 30 μm, and so on))

Layers including embodiments of the functionalized polyhedral oligomeric silsesquioxane composition can have mechanical properties such as elastic modulus of about 4 to 5.5 or about 5.3 GPa, which is advantageous over organic films having an elastic modulus of less than 3 GPa, as measured by nanoindentation or mechanical elongation.

Layers including embodiments of the functionalized polyhedral oligomeric silsesquioxane composition can have a hardness of about 0.2 to 1 GPa.

Layers including embodiments of the functionalized polyhedral oligomeric silsesquioxane composition can be used as masks that have an order of magnitude greater high dry etch selectivity than organic material based masks (e.g., embodiments of the present disclosure have selectivities greater than 2 or greater than 10).

Layers including embodiments of the functionalized polyhedral oligomeric silsesquioxane composition are hydrophobic and have a contact angle of about 80° to 105° or about 85°.

Layers including embodiments of the functionalized polyhedral oligomeric silsesquioxane composition can have excellent adhesion to both photoresist as well as silicon due to the presence of organic/inorganic species.

Layers including embodiments of the functionalized polyhedral oligomeric silsesquioxane composition, which have adequate gas permeation so as to be useful in forming air-gap (where the gaseous products of sacrificial material decomposition can pass through the overcoat without causing it to suffer mechanical failure), can form one or more portions of the enclosure of an air-gap. The functionalized polyhedral oligomeric silsesquioxane composition has a low gas evolution polymeric matrix so that use of this material in a layer assists in maintaining air-gap and/or overcoat properties, especially when metalized for hermetic device packages.

Layers including embodiments of the functionalized polyhedral oligomeric silsesquioxane composition are thermally stable to about 320 to 370° C. or about 350° C.

Layers including embodiments of the functionalized polyhedral oligomeric silsesquioxane composition can have a very high chemical resistance (resistance to solvents and oxidants which dissolve and oxidize organic compounds), which may be partly due to the SiOx cage and the selection of the R group. In particular, embodiments of the present disclosure are chemically resistant to acids (e.g., sulfuric acid, hydrofluoric acid, hydrochloric acid, and hydrogen peroxide), buffered oxide etch (BOE), organic solvents (e.g., mesityene, alcohols, ketones, gamma butyrolactone, propylene glycol, and methyl ether acetate), and the like. For example, solvents and most of the acid baths mentioned above, showed <10 nm/min etching or were completely inert. Thus, thick films (e.g., >1 μm) would require a long process time to etch, and the etching would be anisotropic in nature. As a comparison, the average etch rate for BOE of SiOx is >150 nm/min, so embodiments of the present disclosure are superior to SiOx.

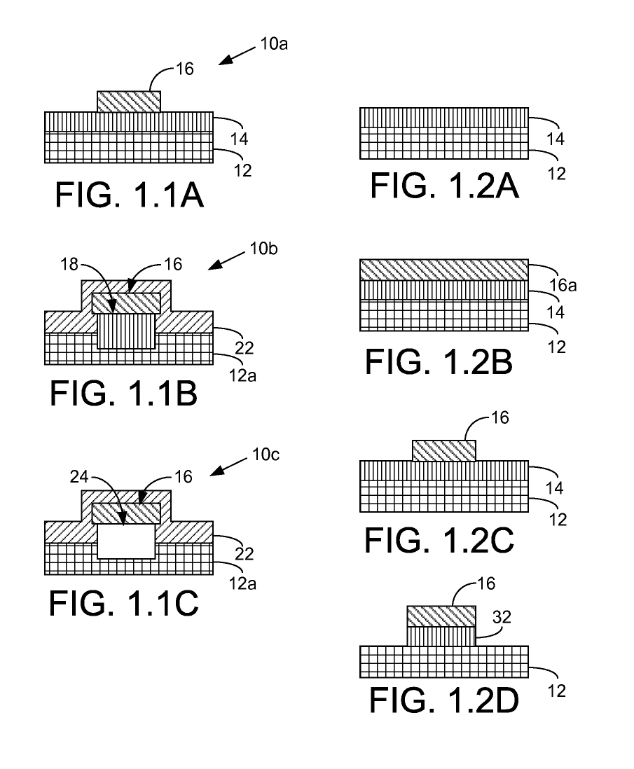

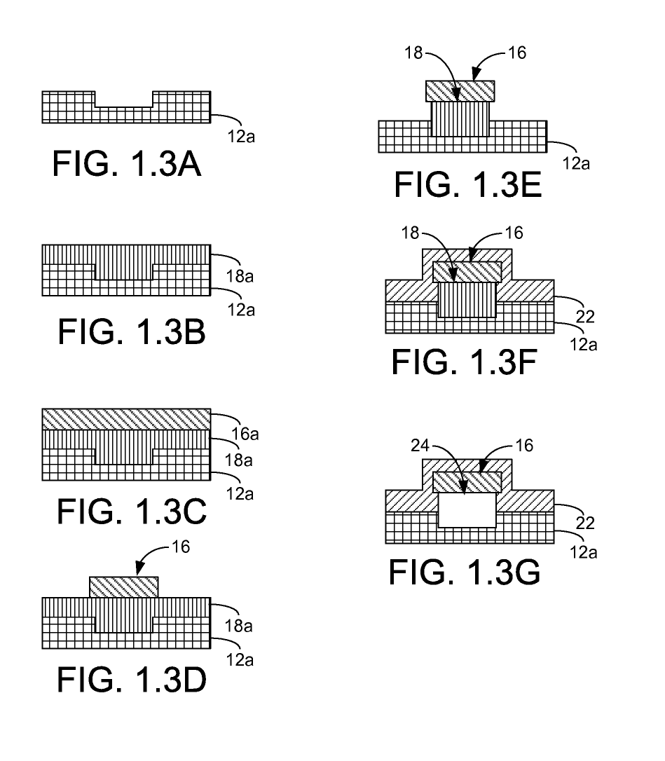

As mentioned above, embodiments of the present disclosure include structures that can be used in electronic devices or processes for forming electronic devices, microfluidic devices, microelectromechanical systems, and optical devices, as described herein. FIGS. 1.1A to 1.1C illustrate exemplar embodiments of structures 10a, 10b, and 10c, that include the functionalized polyhedral oligomeric silsesquioxane composition of the present disclosure. The structures 10a, 10b, and 10c, can be used in a variety of ways in a variety of devices, but these structures are only exemplar embodiments and other configurations are intended to be covered by this disclosure and the claims.

For the purposes of illustration only, and without limitation, embodiments of the present disclosure will be described with particular reference to the below-described fabrication methods. Note that not every step in the process is described with reference to the process described in the figures hereinafter. Therefore, the following fabrication processes are not intended to be an exhaustive list that includes every step required to fabricate the embodiments of the present disclosure.

FIG. 1.1A illustrates a structure 10a that includes a substrate 12, a first layer 14, and a second layer 16. The first layer 14 is disposed on the substrate 12 and the second layer 16 is disposed on a portion of the first layer 14. The second layer 16 is made from an embodiment of the functionalized polyhedral oligomeric silsesquioxane composition as described herein (e.g., mixed with a solvent and spin coated onto the first layer). The second layer 16 can have a thickness such as those described above or about 1 μm to 15 μm or about 3 μm to 15 μm.

The substrate 12 can be made of a single material or can represent a more complicated structure that includes multiple materials and multiple layers of materials, where the substrate can be used in electronics or microfluidics as described herein. In an embodiment, the substrate 12 can include, but is not limited to, silicon based materials (e.g., silicon oxide and silicon nitride), polymers, glass reinforced polymers, metals, glasses, and semiconductors (e.g., GaAs). In an embodiment, the substrate 12 can include, but is not limited to, MEMs, microelectronics, and optics and packaging applications.

The first layer 14 can be made of a single layer or of multiple layers of materials. The first layer 14 can have a thickness of about 0.1 μm to 200 μm. In an embodiment, the first layer 14 can be made of an organic polymer or material or a material with dissimilar chemical and physical properties than the second layer 16. Dissimilar chemical properties would include the rate of oxidation in the presence of reactive oxygen species, as found in reactive ion etching using oxygen and the etching gas. Hydrocarbons rapidly react with reactive oxygen to form carbon dioxide and water. Functionalized polyhedral oligomeric silsesquioxane composition is not reactive in a oxygen plasma. Another example is the reactivity of aluminum to a chlorinated plasma, whereas functionalized polyhedral oligomeric silsesquioxane composition is not reactive in an chlorinated plasma. In another embodiment, the first layer 14 and the second layer 16 can be made of similar materials.

In an embodiment, the first layer 14 can be made of materials such as polynorbornene compounds, polycarbonates, polyimides, and combinations thereof, as well as those described below for the sacrificial layer (See FIG. 1.3E and the corresponding description).

In an embodiment, the second layer 16 can represent an etching mask, which can be used for etching the first layer 14. In an embodiment, the second layer 16 can provide desired mechanical properties for the structure 10a.

FIG. 1.1B illustrates a structure 10b that includes a substrate 12a, an overcoat layer 22, a second layer 16, and a third layer 18. The third layer 18 is disposed on the substrate 12 and enclosed by the second layer 16 and the overcoat layer 22. The second layer 16 is made from an embodiment of the functionalized polyhedral oligomeric silsesquioxane composition as described herein (e.g., mixed with a solvent and spin coated onto the first layer). The second layer 16 can have a thickness of about 1 μm to 50 μm or about 3 to 15 μm. The second layer 16 may have desired mechanical properties. For example, FIG. 1.1C illustrates a similar structure 10c where the third layer 18 has been removed. Thus, the second layer 16 can provide desired mechanical properties to ensure that the air-gap 24 maintains a certain shape or volume. The air-gap 24 can be a vacuum or can include one or more gases, which are not limited to the constituents of air.

In an embodiment, the third layer 18 can be made of a material such as those described above for a first layer 14, while the substrate 12a can be similar to substrate 12 described above.

FIGS. 1.2A through 1.2D are cross-sectional views that illustrate a representative process for fabricating the structure 10a illustrated in FIG. 1.1A. FIG. 1.2A illustrates a first layer 14 disposed on a substrate 12. The first layer 14 can be made of a material similar to those described in reference to first layer 14. FIG. 1.2B illustrates a second layer 16a disposed on the first layer 14, where the second layer 16a is made of the functionalized polyhedral oligomeric silsesquioxane composition as described herein (e.g., mixed with a solvent). The second layer 16a can be formed using spin coating, doctor-blading, spray coating, meniscus coating, and dip coating. The second layer 16a can have a thickness of about 1 μm to 50 μm, where the thickness can be controlled by the material, the solvent used, the process used to form the layer, and the like.

FIG. 1.2C illustrates the second layer 16 after a portion of the second layer 16a has been removed to expose a portion of the first layer 14. The second layer 16a can be removed using reactive ion etching, laser drilling, wet etching, and a combination thereof.

FIG. 1.2D illustrates the removal of the portion of the first layer 14 that is not covered by the second layer 16 to form layer 32. The first layer 14 can be removed using reactive ion etching, laser drilling, wet etching, and a combination thereof.

FIGS. 1.2A to 1.2D represent an exemplar steps for using embodiments of the present disclosure. However, additional processing steps (e.g., soft baking, baking, curing, rinsing, etc) can be included and/or more complicated structures can be processed using these teachings.

FIGS. 1.3A through 1.3G are cross-sectional views that illustrate a representative process for fabricating the structure 10c illustrated in FIG. 1.1C. FIG. 1.3A illustrates a structure having a substrate 12a and FIG. 1.3B illustrates a first layer 18a disposed on the substrate 12a. The first layer 18a can be made of a material similar to those described in reference to first layer 14. FIG. 1.3C illustrates a second layer 16a disposed on the first layer 18a, where the second layer 16a is made of the functionalized polyhedral oligomeric silsesquioxane composition as described herein (e.g., mixed with a solvent). The second layer 16a can be formed using spin coating, doctor-blading, spray coating, meniscus coating, and dip coating. The second layer 16a can have a thickness of about 1 μm to 50 μm, where the thickness can be controlled by the material, the solvent used, the process used to form the layer, and the like.

FIG. 1.3D illustrates the second layer 16 after a portion of the second layer 16a has been removed to expose a portion of the first layer 18a. The second layer 16a can be removed using reactive ion etching, laser drilling, wet etching, and a combination thereof.

FIG. 1.3E illustrates the removal of the portion of the first layer 18a that is not covered by the second layer 16. The first layer 18 can also be referred to as a sacrificial layer. The sacrificial layer can be made of polymers that have a decomposition temperature less than the decomposition or degradation temperature of the polymer bridge material. Examples of the sacrificial layer include compounds such as, but not limited to, polynorbornenes, polycarbonates, polyethers, and polyesters. More specifically the sacrificial layer includes compounds such as BF Goodrich Unity™ 400, polypropylene carbonate, polyethylene carbonate, and polynorborene carbonate. The sacrificial layer may also contain photosensitive compounds, which are additives for patterning or decomposition. The sacrificial material may include photoresists or metals. The sacrificial layer can be deposited using techniques such as, for example, spin coating, doctor-blading, sputtering, lamination, screen or stencil-printing, melt dispensing, chemical vapor deposition (CVD), and plasma based deposition systems.

FIG. 1.3F illustrates disposing an overcoat layer 22 onto the substrate 12a, the second layer 16, and the first layer 18. The overcoat layer 22 can be a material such as polyimide, epoxy, silicon dioxide, silicon nitride, and metal. The overcoat layer 22 can be disposed using techniques such as spin-coating, spraying, dipping, and plasma deposition. In general, layer 22 is chosen to protect the component from environmental conditions it will experience during its life.

FIG. 1.3G illustrates removing the first layer 18 to form a three dimensional air-gap 24. The second layer 16, the overcoat layer 22, and the substrate 12a enclose the three dimensional air-gap 24. The height of the air-gap 24 can be about 0.1 μm to 100 μm and have a width and length of about 1 μm and 1 cm.

FIGS. 1.3A to 1.3G represent an exemplar steps for using embodiments of the present disclosure. However, additional processing steps (e.g., soft baking, baking, curing, rinsing, etc) can be included and/or more complicated structures can be processed using these teachings.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

### Brief Introduction

A photodefineable dielectric was developed using epoxycyclohexyl polyhedral oligomeric silsesquioxanes (POSS) and a photo-catalyst. POSS is a hybrid organic/inorganic dielectric which has favorable mechanical and chemical stability for use as a permanent dielectric in microfabrication. Sharp, 10 μm wide features were formed from POSS using 365 nm radiation. The optical contrast was 1.51. POSS films were thermally stable to 350° C. and demonstrated chemical stability in a variety of solvents and oxidants. The polymer film had an elastic modulus of 4.1 GPa and a hardness of 0.45 GPa. The POSS had high etch selectivity compared to organic films for pattern transfer.

### Discussion

Polyhedral oligomeric silsesquioxane (POSS) is a hybrid inorganic/organic compound with interesting film properties. POSS has a rigid silicon oxide cage with functionalized organic side groups which can be used for cross-linking. POSS has been used in microelectronics as a nanocomposite additive in organic polymers to improve mechanical properties.^{6, 7} Functionalized POSS has also been studied in combination with a curing agent or copolymer to form films. The use of a glycidyl ether functionalized POSS cross-linked with a diamine curing agent has been modeled as a potential chip underfill by Lin, et al.⁸ Asuncion and Laine investigated films formed from an amine functionalized POSS which was cross-linked with an epoxy based or anhydride based curing agents for an oxygen barrier in electronic packaging.⁹ A photosensitive POSS structure functionalized with acrylate and benzocyclobutane moieties has been synthesized and investigated as a flash imprint film.^{10, 11}

In this study, a novel POSS dielectric has been developed using only epoxy functionalized POSS as the monomer. The use of epoxy functionalized POSS allows fabrication of a photo-definable, highly cross-linked, dense film with organic/inorganic characteristics. The films were spin-coated and had excellent mechanical and thermal properties. Processing conditions were optimized, and the optical, thermal, mechanical, and chemical properties were evaluated and compared to organic-only epoxy dielectrics. POSS was investigated in several MEMS applications including as a high selectivity permanent mask for pattern transfer to an organic sacrificial polymer film. An air-cavity process using a patterned sacrificial polymer was demonstrated.

### Experimental

Epoxycyclohexyl POSS (Hybrid Plastics, Inc.) was used in this study. It consists of a silicon oxide cage structure with an epoxycyclohexyl group on each corner, (C₈H₁₃O₂)ₙ(SiO_{1.5})ₙ where n=8, 10, or 12. The formulation is a mixture of 8, 10, and 12 cornered POSS molecules and corresponding epoxy groups. An example of the 8 cornered POSS is shown in FIG. 2.1.

POSS was dissolved in mesitylene making 40 wt % or 60 wt %, solids solutions. An iodonium photo-acid generator (PAG) was added at 1 wt % of POSS and sensitizer at 0.33 wt % of POSS so as to make the formulation photosensitive at 365 nm.

POSS samples were spin coated onto <100> silicon wafers and then soft-baked on a hotplate at 85° C. for 5 minutes to remove the solvent from the polymer film. A 1 kW Hg—Xe lamp with a broad band filter over 350-380 nm was used for exposure with an optimal dose of 250 mJ/cm². The lamp intensity was calbrated using a broadband detector for the entire range of 350-380 nm. The post-exposure bake (PEB) was performed on a hotplate at 85° C. for 5 minutes. The films were developed in an agitated isopropanol bath followed by a deionized water spray rinse. The films were cured in a nitrogen-purged tube furnace. The temperature was ramped at 1° C./min and held at the cure temperature, 240° C., for 1 hour. The furnace was allowed to cool slowly by natural convection to room temperature before the samples were removed.

A Zeiss Ultra 60 scanning electron microscope (SEM) was used to obtain images. Film thicknesses were measured with a Veeco Dektak profilometer. A tape test was used to investigate POSS adhesion. After processing, a cross-hatched pattern was made in the POSS film followed by tape testing. The thermal stability was measured using a TA instruments Q50 thermal gravimetric analysis (TGA). The POSS film was typically heated to 500° C., using a 1° C./min ramp rate.

A variable density optical mask (Opto-line International, Inc.) was used to study the effect of dose on contrast and pattern resolution. The mask allowed for the POSS to be exposed to multiple doses on a single wafer. The exposed features were developed and used to measure D₀, D₁₀₀ so that the contrast (γ) could be determined, Equation 1. Where D₁₀₀ is the exposure dose at which all the material remains and D₀ is the exposure dose at which all of the photodefined material is removed.

$$γ = \frac{1}{{log}_{10} ( \frac{{D}_{100}}{{D}_{0}} )} \qquad ( 1 )$$

UV absorption was measured with a Hewlett Packard 8543 UV-vis spectrophotometer using the Beer-Lambert law, Equation 2.

$$\frac{I}{{I}_{0}} = {10}^{- α l} \qquad ( 2 )$$

where, I₀ is the incident intensity, I is the intensity at a pathlength I, and α is the absorption coefficient. The hydrophilic/hydrophobic nature of POSS films was investigated using water contact angle measurements with a Rame-Hart CA goniometer (model 100). For the measurements, 4 μL water drops were brought into contact with a POSS film, and still images were recorded and analyzed.

Quasi-static nano-indentation was conducted on the samples using a Hysitron Triboindenter with a Berkovich tip. The process and characterization necessary to obtain the modulus and hardness followed the procedures of Rajarathinam, et al.¹² RIE of POSS was investigated to study the potential use of POSS as a hard mask for pattern transfer to other materials such as polypropylene carbonate (PPC) (Novomer, Inc.). The PPC films were made by dissolving the polymer in γ-butyrolactone, typically 18 wt % polymer. PPC samples were spin coated onto <100> silicon wafers and then soft-baked on a hotplate at 100° C. for 5 minutes to remove the solvent. Polynorbornene based dielectrics, Avatrel 2000P (Promerus, LLC) and Avatrel 8000P (Promerus, LLC) were used as organic masks for comparison to a POSS mask. Avatrel 2000P was processed according to the procedures of Bai, et al.^{13, 14} Avatrel 8000P was processed according to the procedures of Rajarathinam, et al.¹² A Plasma-Therm RIE operating at 13.56 MHz was used to measure etch selectivity. The pressure and power were held constant at 310 mTorr and 250 W, respectively. The ratio of O₂ to CHF₃ gas in the RIE chamber was optimized for maximum etch selectivity and minimal residue.

The POSS films developed here were used in a MEMS packaging application. The POSS build-up process was used to form a clean, durable cavity for packaging by using POSS as an overcoat for the PPC sacrificial material. A 3 μm film of PPC was spun on a silicon wafer and soft-baked. A 2 μm film of POSS was then spin coated on top of the PPC film and processed. The exposed PPC was reactive ion etched using the optimized etch conditions leaving patterned POSS on top of patterned PPC. The samples were fully encapsulated with an overcoat of POSS or Avatrel 2000P. The samples were then heated and metallized in a Kurt J. Lesker PVD75 filament evaporator. The samples were heated under vacuum to 240° C. and held at temperature for 2 hours to decompose the sacrificial PPC. The samples were allowed to cool under vacuum and 1 μm of aluminum was deposited on the samples. FIG. 2.2 shows a simple schematic of the process and final cavity.

### Results and Discussion

The optical, mechanical, and chemical properties of photodefined POSS were investigated. Thin POSS films were also studied for use as a masking material for sacrificial organic polymers in MEMS packaging applications.

POSS thin films were deposited by spin coating using mesitylene as the casting solvent. The viscosity of the POSS-solvent mixture and resulting film thickness was adjusted by changing the percent solids in the mixture. A 60 wt % and 40 wt % POSS formulation in mesytilene were prepared and spin-coated onto 100 mm diameter silicon wafers with a 120 nm thermal oxide. Spin speeds from 500 and 4000 revolutions per minute (rpm) were used. The samples were spin-coated at 500 rpm for 10 seconds, ramped to the desired speed, and held at speed for 10 seconds. The samples were then soft-baked on a hot plate at 85° C. until the films were tacky. The soft bake time increased with film thickness. For example, the 12 μm film was soft baked for 10 minutes on a hot plate while the 2 μm film was baked for 3 minutes. The wafer was exposed to UV radiation at a dose of 250 mJ/cm² and a post exposure bake at 85° C. for 5 minutes. The wafers had a visibly even coat on the wafer except for the edge bead which covered the outermost 4 mm of the wafer coated at 500 rpm. The final film thickness, as measured at two locations on the wafer, is shown in FIG. 2.3. The 60 wt % POSS solution had a single-coat thickness of 5 μm to 12 μm whereas the 40 wt % POSS solution produced thickness from 2 μm to 4 μm. Other formulations can be used to expand the thickness range.

The photospeed and contrast were evaluated using 1.5 μm thick films of the 40 wt % POSS mixture. The POSS film was softbaked at 85° C. and exposed through a variable density optical mask with a broadband wavelength of 350-380 nm. The material is a negative-tone dielectric which crosslinks in the exposed areas. The sample was then post exposure baked at 85° C. for 5 minutes. The film was developed in an agitated isopropanol bath for 2 minutes to dissolve the unexposed film. The development time was determined by the appearance of a translucent residual film on the surface, indicating that the unexposed film had cleared. The residual film was removed by using a deionized water spray for 1 minute. The remaining polymer thickness for each dose was measured with a profilometer. The D₀ and D₁₀₀ were found to be 19.4 mJ/cm² and 89.4 mJ/cm², respectively. The contrast value was calculated from FIG. 2.4 to be 1.51. Some of the polymer regions exposed at doses at or near D₀ and D₁₀₀ had undergone some degree of delamination from the silicon surface during development. Delamination was exacerbated by vigorous agitation during the developing process. Features exposed to doses between 29.8 mJ/cm² and 58.08 mJ/cm² had less than 25% of the features remaining on the surface after development. Features exposed to doses above 58.08 mJ/cm² showed layered development with a large fraction of the film intact. The sensitivity is similar to SU-8, which has a value of 40 mJ/cm² for a 30 μm film.¹² The contrast is comparable to Novolac-based photoresists, which have contrast values for thin films from 0.7 to 3.6.¹⁵

The adhesion of the POSS layer was investigated by using a simple pass/fail tape test. The POSS layer was scribed with a cross-hatched pattern prior to the tape test. Adhesion of POSS, especially at the edges of the scribe marks, was visually examined. The POSS films were 1.5 μm thick and cast from a 40 wt % POSS solution. The minimum exposure dose to achieve adhesion was investigated. Samples were spun onto a wafer and soft baked at 85° C. for 3 minutes. A range of exposure doses were used. The samples were post exposure baked at 85° C. for 5 minutes prior to tape testing. Doses greater than 150 mJ/cm² showed good adhesion to the surface for samples on freshly HF-cleaned wafers and those with a native oxide. When the POSS was deposited on 120 nm of thermally-grown oxide, the adhesion improved. The minimum dose necessary to pass the tape test on thermally-grown oxide was 110 mJ/cm².

The effect of post-POSS processing, especially heating, on adhesion was investigated. The exposed and developed POSS samples were heated (i.e., cured) at 240° C. for 2 hours in ambient atmosphere and retested for adhesion. All samples passed the adhesion test after heating to 240° C.

The absorbance of the POSS mixture in the UV-Vis region was investigated. POSS films deposited from the 60 wt % solution were spin-coated on silica glass slides. As shown in FIG. 2.5, the absorption coefficent was found to be 63 cm⁻¹ at 365 nm for a softbaked POSS film. The absorption coefficent at 365 nm dropped after PEB to 37.8 cm⁻¹. The decrease in the absorption coefficent can be attributed to the decomposition of the sensitizer and PAG, the main absorbing groups in the film. Soft baked POSS films with a thickness of 4.2 μm, 7.3 μm, and 10 μm, had an absorption coefficient of 60 cm⁻¹, 63 cm⁻¹, and 66 cm⁻¹, respectively. A least squares result for absorbance vs thickness showed a linear relationship with a zero x-intercept and slope of 65 cm⁻¹. The absorption coefficient affects sensitivity and contrast, especially for thick films where the optical dose is attenuated in the bulk of the film. For example, in order to achieve a minimum dose at the greatest depths, the surface is overexposed. Thus, a 15 μm thick film experiences 10% attenuation throughout the film. The 1 μm film passed the tape test with no delamination at a dose of 150 mJ/cm² while the 15 μm showed minor delamination due to the lower dose at the bottom of the film.

The photosensitivity and pattern fidelity of POSS was investigated. POSS films were spin-coated from a 60 wt % solution at 1250 RPM forming a 10 μm thick film and were then softbaked. The films were irradiated with broadband radiation (wavelength of 350 to 380 nm) through a variable-density mask. The films were PEB, developed in isopropanol, and rinsed to cleanly remove the unexposed film, as described previously. The features with the highest spatial resolution in terms of maintaining size, pitch, and sharp corners/edges were exposed at 250 mJ/cm². Features exposed to doses below 250 mJ/cm² delaminated and had poor shape definition. At higher exposure dose, the features had poor pitch fidelity, and rounded edges. FIG. 2.6(a) shows an array of 10 μm thick POSS lines ranging from 5 to 50 μm in width with equal lines and spaces. Features above 10 μm in width had excellent pattern fidelity. These features maintained full pitch and showed clean, sharp corners matching the features on the mask. FIG. 2.6(b) shows 50 μm wide lines in more detail. The sidewalls are well defined and straight-walled but have a degree of line edge roughness. Features below 10 μm in width had increased rounding of the edges, poor pitch fidelity, and increased delamination for the smaller structures. Thus, the minimum spatial resolution for the 10 μm thick film was approximately the same as the film thickness, one-to-one aspect ratio of thickness-to-width. For thinner POSS films (e.g., 3 μm thick), finer features could be resolved, however the spatial resolution was again limited to the one-to-one (thickness-to-width) aspect ratio. Higher aspect ratio structures (i.e., finer features for a given thickness) can likely be achieved by optimizing the exposure, baking, and developing conditions.

The chemical resistance of the POSS films was investigated by testing for delamination, cracking, and excessive swelling when exposed to acids and solvents used in fabrication. POSS films (5 μm thick) were immersed in various liquids for 15 minutes. The liquids included isopropanol, acetone, mesitylene, propylene glycol methyl ether acetate, 2-hexanone, hot 3 M sulfuric acid, peroxydisulfurfic acid (often called piranha etch), phosphoric/acetic/nitric acid etch, and buffered oxide etch. Samples were periodically removed from the solutions to measure the POSS thickness. Buffered oxide etch had the highest POSS dissolution rate, 67 nm/min. The dissolution rate for the other liquids was less than 6.7 nm/min. The films showed no visible damage or swelling after being submerged in any of the baths. A sample was also placed in concentrated HF, and the film quickly released from the wafer and disintegrated. The silicon oxide cage/epoxy hybrid structure of POSS gives the cross-linked film improved resistance to chemical attack that otherwise would affect organic polymer films or silicon dioxide films.

The thermal stability of POSS was investigated by TGA. A small sample of an exposed film was heated at 1° C./min to 500° C. FIG. 2.7 shows some weight loss of POSS film at 350° C., which is likely due to the organic content of POSS decomposing. The remaining silicon oxide, ca. 45%, decomposed at higher temperature. The mass loss at temperatures below 250° C. is likely due to loss of residual solvent (70° C. to 160° C. range), and loss of water produced during the epoxy cross-linking within the film at temperatures above 170° C. The mechanical stability of the cross-linked 6 μm thick POSS films were examined after heating to 250° C. and repeated at higher temperatures in 25° C. intervals. Each sample was held at temperature for one hour in a nitrogen atmosphere. Cracks were visible in samples heated to 350° C., which corresponds to the degradation temperature in the TGA result.

The hydrophilic/hydrophobic nature of the POSS films was investigated using contact angle measurements with a Rame-Hart CA goniometer. A 5 μm POSS film was post exposure baked and brought in contact with a 4 μL water drop, and the contact angle was measured. The measured contact angle was 85.0±1.5 degrees. The film was then cured at 240° C., and the measurement was repeated. The contact angle did not change showing a hydrophobic character. The contact angle of silicon dioxide is generally 25 degrees or less.¹⁶ The contact angle of silicon dioxide after treatment with silane coupling agents was measured. Treatment with trimethyl methoxysilane, phenyldimethyl ethoxysilane, and trifluoropropyl dimethylchlorosilane gave contact angles of 68°, 68°, and 83°, respectively.¹⁷

The elastic modulus and hardness of POSS was studied using nanoindentation. A 5 μm thick films was measured using a Berkovich tip after PEB. The film was found to have a reduced modulus of 4.9 GPa and a hardness of 0.56 GPa. POSS films were then cured to 205° C. to 240° C. and held for 2 hours in a nitrogen atmosphere. The 205° C. and 240° C. cured POSS films had a modulus of 5.3 GPa, and 4.1 GPa, and hardness of 0.64 GPa and 0.41 GPa, respectively. The change in modulus is due to the epoxy cross-linking resulting in an increase in modulus followed by thermal degradation of the cross-link bonds above 205° C. causing a slight drop in modulus. The POSS elastic modulus is comparable to SU-8, a photodefinable epoxy polymer used in MEMS structures, which had a modulus of 4.02 GPa ¹⁸

The use of POSS as a hard mask in reactive ion etching for pattern transfer was investigated. The silicon dioxide nature of POSS results in low etch rate in an oxygen plasma compared to an organic polymer film. PPC was patterned using POSS as the etch-resistant mask. 5 μm thick PPC films with POSS-overcoat were etched in an oxygen plasma at 310 mTorr pressure and 250 W power. The etch gas was O₂ with 0 to 10% CHF₃. The CHF₃ was used to assist in polymer etching and minimize the hydrocarbon residue. The film thickness was measured every 30 seconds during the etch process to determine etching rate. The corresponding POSS etch rates and selectivity are shown in Table 1. The PPC etch rate was 0.66 μm/min etch rate using 94% oxygen and 6% CHF₃. The etch selectivity, shown in Table 1, drops at higher CHF₃ concentrations because the fluorinated products attack the SiO bonds. High CHF₃ concentrations can be used to remove the POSS after polymer etching, if necessary. The POSS etch rate in the 94% O₂ with 6% CHF₃ plasma was compared to Avatrel 2000P and Avatrel 8000P etch rate, which can also be used for pattern transfer. The etch rate of Avatrel 2000P and Avatrel 8000P was 0.44 μm/min and 0.35 μm/min, respectively. The selectivity of Avatrel 2000P and Avatrel 8000P with respect to PPC is 1.5 and 1.9, respectively, compared to 24 for POSS. The combination of high modulus, chemical and thermal stability, and high selectivity are desirable attributes making POSS an interesting, permanent dielectric or temporary etch mask.

POSS was used as the overcoat and pattern transfer material in a MEMS packaging application. A thin film of PPC was patterned and etched using POSS as the pattern transfer mask, as shown in FIG. 2.8(a). The PPC feature is a 25 μm wide line and is 3 μm thick. A 1 μm thick layer of POSS was coated on the PPG and imaged so as to serve as the etch mask. The PPC field region was clean after 5 minutes of etching in a 94% O₂, 6% CHF₃ reactive ion etch condition, as described above. The PPC undercut was 500 nm after the plasma etch.

POSS was then used as the overcoat for the PPC/POSS structure in fabricating buried microchannels that could be used in MEMS packaging. The microchannels would take the shape of the PPC region in the PPC/POSS structure. Dimensions of 50 to 100 μm wide, 1 cm in length, and 3 μm tall were necessary for the microchannel structures. A 3 μm film of PPC was spin-coated and a POSS pattern transfer mask was deposited over the sacrificial PPC. The sample was then plasma etched in 94% O₂, 6% CHF₃ for 5 minutes to transfer the pattern from the POSS to the PPC. The POSS etch mask was left in place so as to provide additional support to the top of the cavity. Several overcoat materials on top of the POSS to encapsulate the cavities were investigated. The overcoat should have adequate mechanical support to maintain the cavity shape and allow the decomposition products to permeate the overcoat leaving a gas-cavity. Three overcoats were investigated: 2 μm Avatrel 2000P, 2 μm POSS overcoat, and 1 μm POSS with 2 μm Avatrel 8000P. The latter composite overcoat (POSS Avatrel) used the POSS to protect the PPC from deformation from the solvent used in Avatrel 8000P. After the air-cavity was formed, a thin layer of aluminum was evaporated on to the POSS or Avatrel to improve the mechanical rigidity of the structure. A brief oxygen plasma clean of the POSS surface was done at low power to improve the adhesion of the final metal cap evaporated on the air-cavity structure. The decomposition of the PPC could be performed in the same vacuum chamber as the aluminum deposition, just before evaporation or in a separate chamber before evaporation. 1 μm of aluminum was used to hermetically seal the cavity. The microchannel cavities were cross-sectioned and observed under SEM. FIG. 2.9 shows a cavity using Avatrel 2000P as the overcoat in the microchannels. The cavity retained the shape of the PPC and showed no deformation of the Avatrel/aluminum overcoat. The POSS mask was left in place after pattern transfer in FIG. 2.9(a), providing additional mechanical support for the top of the cavity. FIG. 2.9(b) shows the corner of the cavity from FIG. 2.9(a). All layers can be seen and have the correct thickness with cleanly defined cavity walls. Cavities using POSS as the pattern transfer material and POSS/Avatrel 8000P overcoat showed similar results with respect to edge and shape definition. FIG. 2.10 shows a cross-section of an all POSS overcoat MEMS packaging application for a resonator. The resonator cavity dimensions were 3 μm high, 60 to 300 μm wide, and 100 to 500 μm long and was made using a similar process as above. The two trenches in the wafer are to resemble a dummy setup of an actual resonator device. The overcoat maintains the shape of the PPC filled cavity and clean decomposition of the sacrificial material shows that the resonator would be free of debris. The cavities could be made to contain an inert gas, or vacuum, depending on the metal deposition conditions. Further investigation will demonstrate the process on functioning MEMS resonators, hermetic conditions and suitability for lead frame packaging.

### CONCLUSION

The epoxy POSS dielectric provides a resilient, strong inorganic/organic hybrid dielectric for use in microfabrication. The POSS dielectric uses simple processing steps for film fabrication and exhibits adequate optical properties and photodefineability. Its thermal and chemical stability allow for a tough, durable overcoat. A high plasma etch selectivity compared to organic polymers was demonstrated. The POSS dielectric was used to create microchannels with its RIE patterning capabilities. The microchannels used POSS as a protective chemical barrier and as a mechanical overcoat. An all-POSS overcoat using a similar process as the microchannels showed potential for hermetic MEMS packaging.

References, each of which is incorporated herein by reference:
[1] P. Monajemi, P. J. Joseph, P. A. Kohl and F. Ayazi, J. Micromech. Microeng. 16, 742 (2006).
[2] P. J. Joseph, P. Monajemi, F. Ayazi and P. A. Kohl, IEEE Trans. Adv. Packaging 30, 19 (2007).
[3] M. Rais-Zadch, P. A. Kohl and F. Ayazi, J. Microelectromech. S. 17, 78 (2008).
[4] M. Esashi, J. Micromech. Microeng. 18, 13 (2008).
[5] P. J. Joseph, H. A. Kelleher, S. A. B. Allen and P. A. Kohl, J. Micromech. Microeng. 15, 35 (2005).
[6] J. Choi, A. F. Yee and R. M. Laine, Macromolecules 36, 5666 (2003).
[7] H. M. Lin, K. H. Hseih and F. C. Chang, Microelectron. Eng. 85, 1624 (2008).
[8] E. K. Lin, W. L. Wu, C. X. Zhang and R. M. Laine, Int. Sym. Adv. Pkg, Mat. 63 (1999).
[9] M. Z. Asuncion and R. M. Laine, Macromolecules 40, 555 (2007).
[10] F. Palmieri, M. D. Stewart, J. Wetzel, J. Hao, Y. Nishimura, K. Jen, C. Flannery, B. Li, H.-L. Chao, S. Young, W. C. Kim, P. S. Ho and C. G. Willson, edited by J. L. Michael P. Soc. Photo-opt. Ins. 61510J (2006).
[11] J. Hao, M. W. Lin, F. Palmieri, Y. Nishimura, H.-L. Chao, M. D. Stewart, A. Collins, K. Jen and C. G. Willson, edited by J. L. Michael P. Soc. Photo-opt. Ins. 651729 (2007).
[12] V. Rajarathinam, C. H. Lightsey, T. Osborn, B. Knapp, E. Elce, S. A. B. Allen and P. A. Kohl, J. Electron. Mater. 38, 778 (2009).
[13] Y. Q. Bai, P. Chiniwalla, E. Elce, S. A. B. Allen and P. A. Kohl, J. Appl. Polym. Sci. 91, 3031 (2004).
[14] Y. Q. Bai, P. Chiniwalla, E. Elce, R. A. Shick, J. Sperk, S. A. B. Allen and P. A. Kohl, J. Appl. Polym. Sci. 91, 3023 (2004).
[15] J. N. Helbert, Handbook of VLSI Microlithography—Principles, Technology and Applications William Andrew Publishing/Noyes (Norwich N.Y. 2001).
[16] K. K. Reinhardt, Werner, Handbook of Silicon Wafer Cleaning Technology William Andrew Publishing (Norwich, N.Y. 2008).
[17] J. L. Salas-Vernis, J. P. Jayachandran, S. Park, H. A. Kelleher, S. A. B. Allen and P. A. Kohl, J. Vac. Sci. Technol. B. 22, 953 (2004).
[18] B. Bhushan, Springer Handbook of Nanotechnology Springer—Verlag (Heidelberg, Germany 2004).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%., 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are merely set forth for a clear understanding of the principles of this disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A composition, comprising:
a functionalized polyhedral oligotheric silsesquioxane and a photocatalyst, wherein the functionalized polyhedral oligomeric silsesquioxane includes a cross-linkable group, wherein the functionalized polyhedral oligomeric silsesquioxane is about 80 to 99.9 weight % of the composition, and the photocatalyst is about 0.01 to 5 weight % of the composition, and optionally about 0.01 to 10 weight % of one or more additional components.

2. A composition, consisting essentially of: a functionalized polyhedral oligomeric silesquixane and a photocatalyst, and optionally an additional component, wherein the functionalized polyhedral oligomeric silsesquioxane includes a cross-linkable group.

3. A composition, consisting of: a functionalized polyhedral oligomeric silsesquioxane and a photocatalyst, wherein the functionalized polyhedral oligomeric silsesquioxane includes a cross-linkable group, wherein the functionalized polyhedral oligomeric silsesquioxane and the photocatalyst are dissolved in a solvent, and optionally an additional component.

4. The composition of claim 1, wherein the functionalized polyhedral oligomeric silsesquioxane is a cage-shaped oligomer represented by the formula Rₙ(SiO_{1.5})ₙ, wherein n is 8, 10, or 12, wherein the functionalized polyhedral oligomeric silsesquioxane has a structure having n number of corners, wherein Si is located at each corner and an R group is attached to the Si, the functionalized polyhedral oligomeric silsesquioxane structure is a three dimensional cage structure, wherein each R is independently selected from the group consisting of: H, a substituted or unsubstituted cyclic aliphatic group, a substituted or unsubstituted linear aliphatic group, a substituted or unsubstituted aryl group, and a combination thereof.

5. The composition of claim 1, wherein the photocatalyst is selected from the group consisting of: triflic acid group catalysts, nonaflic acid group catalysts, FABA acid group catalysts, sulfonate (non-fluorinated) acid group catalysts, and a combination thereof.

6. The composition of claim 1, wherein the composition is dissolved in a solvent selected from the group consisting of: mesitylene, gamma butyrolactone, ketone, alcohol, propylene glycol methyl ether acetate, anisole, N-methylpyrollidone, and a combination thereof.

7. The composition of claim 1, wherein the additional component is selected from the group consisting of: a sensitizer, an antioxidant, an adhesion promotor, and a mixture thereof.

8. A structure, comprising:
a second layer made of a composition comprising a functionalized polyhedral oligomeric silsesquioxane that is disposed on a portion of a first layer, wherein the first layer is disposed on a substrate, wherein the second layer has a thickness of about 1 to 50 μm.

9. The structure of claim 8, wherein the first layer is made of an organic polymer.

10. The structure of claim 8, wherein the composition is selected from any one of the compositions described in claim 1.

11. The structure of claim 8, wherein the second layer is a patterning layer so that portions of the first layer not having the patterning layer disposed on it are removable.

12. The structure of claim 8, further comprising a third layer disposed on the second layer and the first layer, wherein the second layer, the third layer, and the substrate enclose a three dimensional area of the first layer.

13. The structure of claim 12, wherein the three dimensional area of the first layer is removable to form a three dimensional air-gap.

14. The structure of claim 8, wherein the structure includes one or more types of components selected from the group consisting of: a microelectronic component, a microfluidic component, a MEMS component, an optical device component, and a combination thereof.

15. The structure of claim 8, wherein the second layer has a thickness of about 2 to 20 μm.

16. The structure of claim 8, wherein the second layer has a thickness of about 3 to 15 μm.

17. A method, comprising:
disposing a second layer made of a composition comprising a functionalized polyhedral oligomeric silsesquioxane on a portion of a first layer, wherein the first layer is disposed on a substrate, wherein the second layer has a thickness of about 1 to 50 μm;
removing a portion of the second layer to expose a portion of the first layer; and
removing the portion of the first layer that is not covered by the second layer.

18. The method of claim 17, further comprising:
disposing a third layer on the second layer and the first layer, wherein the second layer, the third layer, and the substrate enclose a three dimensional area of the first layer; and
removing the three dimensional area of the first layer to form a three dimensional air-gap, wherein the second layer and the third layer enclose the three dimensional air-gap.

19. The method of claim 17, wherein the composition is selected from any one of the compositions described in claim 1.

20. The method of claim 17, wherein the second layer has a thickness of about 2 to 20 μm.

21. The method of claim 17, wherein the second layer has a thickness of about 3 to 15 μm.
